(19) United States
(12) Patent Application Publication
(10) Pub. No.: US 2016/0071212 A1
(43) Pub. Date: Mar. 10, 2016

(54) Structured and unstructured data processing method to create and implement investment strategies

(71) Applicant: Perry H. Beaumont, Ridgefield, CT (US)

(72) Inventor: Perry H. Beaumont, Ridgefield, CT (US)

(21) Appl. No.: 14/481,675

(22) Filed: Sep. 9, 2014

(51) Int. Cl. G06Q 40/06; G06F 17/30

(52) U.S. Cl. CPC G06Q 40/06; G06F 17/30994

(57) ABSTRACT

The present disclosure provides for contemporaneous evaluation of structured and unstructured data on a single integrated platform, facilitating the creation and implementation of investment strategies. Functionality includes the ability to modify data with a variety of statistical and mathematical operations, and the saving, exporting, and sharing of analyses. It is additionally possible to set up alerts, translate analyses into trading instructions for market brokers, include additional datasets, and generate parameters for predictive analytics. Function calls can be processed manually or in a batch mode, and events can be imposed to occur sequentially within specified timeframes as pre-conditions for investment actions being taken. Preferred performance profiles can be expanded so as to permit an automated process of identifying opportunities among alternative investments.

### BACKGROUND OF THE INVENTION

The present disclosure relates to a system and method to permit the processing of structured and unstructured data to support the creation and implementation of investment activities.

Structured data is commonly defined as data that resides in a fixed field within a record or file. Examples of structured data would include data contained in relational databases and spreadsheets, as with a time series of equity prices or census figures. Unstructured data is commonly defined as information that does not reside in a traditional row and column database, and examples would include the text of a company report or a news release issued by a government agency. It is presently possible to transform structured data into a chart, as with showing the pattern of stock prices over time. It is also possible to transform unstructured data into a chart, as with capturing and reporting the number of instances certain keywords or phrases appear within textual contexts. An existing gap, however, relates to having a process that can simultaneously process structured and unstructured data, and within a platform that additionally permits a variety of advanced manual or automated charting and analytical capabilities. By providing a venue that facilitates the contemporaneous analysis of two disparate data-types on a single integrated platform, as well as easily accommodating the inclusion of new databases, unique insights are now permissible.

The present disclosure addresses the desirability of having a contemporaneous processing of structured and unstructured data within a single integrated platform that also facilitates advanced charting and analytics, and either manually or in an automated fashion. Structured and unstructured data may reside on a personal computer, on a stand-alone storage device, on a server, in the cloud, or with a combination of these, and connections to the data may involve simply opening up a local file or making use of an Application Programming Interface (API), a Software Development it (SDK), or other resources. In brief, datasets can take many forms, be stored in a variety of ways, and be retrieved by different methods. The present invention offers a single integrated platform whereby accommodations are made for all of these considerations. With special challenges related to unstructured information generally, a contribution of the present invention relates to its unique treatment of information that does not have a pre-defined data model or is not otherwise organized in a pre-defined manner. The present invention not only permits different means by which unstructured data can be integrated into a single platform alongside structured data, but also solves for how analyses can incorporate these disparate datasets into investment analysis.

One means by which to build a bridge between structured and unstructured data is to transform unstructured data into elements conducive for a table format. For example, if the unstructured dataset were a set of text documents, the user could specify a list of keywords and phrases of interest with those documents. If the documents were a collection of analyst reports related to various equities, then keywords and phrases of interest might include “Buy recommendation”, “Sell recommendation”, “Undervalued”, “Overvalued”, “Opportunity”, and “Risk”. The user could then create a database table that would store these terms in relation to particular equities along with a timeframe when documents were issued. One particular analysis might involve querying the number of times in the past year when General Electric was cited in a positive way (“Buy recommendation”, “Undervalued”, “Opportunity”), and showing in a chart how this correlates with the price performance of GE (the ticker symbol for General Electric's publically-traded equity).

As an alternative to transforming unstructured data into a format commensurate with how structured data is organized, we could simply permit the unstructured data to remain unstructured. That is, we could allow for an information search and retrieval process to exist whereby a new data profile is created every time a query is generated. Building upon our example with General Electric, instead of having pre-defined tables populated with various keywords and phrases, the user could create their own preferred Boolean search string of relevant items on a real-time basis. Specifically, the user could format a query in the context of GE as “Buy recommendation OR Undervalued OR Opportunity”, and with results returned in a context of frequency and timeframe. The user could then be presented with a chart of the relationship between the price performance of GE and the magnitude and timing of analyst sentiments related to GE.

The advantages of a full text search platform versus a table format platform are significant, and include, though are not limited to: (i.) the ability to have any searchable text remain within its native format (a searchable document in Word or Portable Document Format or Excel or many other formats); (ii.) any document not in a searchable format can be converted for search and retrieval purposes, and; (iii.) Boolean search functionality is powerful, permitting not only the sourcing of keywords or phrases in a dynamic fashion, but also with the ability to include nearby relationships. For example, to conduct a search on “Buy recommendation”, “Undervalued”, and “Opportunity”, and also have results include any references to the word “Strong” occurring within proximity of five words to these keywords, the Boolean instruction would be written as “((Buy recommendation OR Undervalued OR Opportunity) W/5 (Strong))” Boolean functionality additionally permits fuzzy searches, searches for symbols including Greek letters often found in financial formulae, and searches may be conducted in multiple languages inclusive of Japanese, Korean, Chinese, and Russian.

The present invention provides for the interaction of structured and unstructured data on a single integrated platform such that charts of combined data can be evaluated and modified with a variety of statistical and mathematical operations. The inclusion of unstructured data can be achieved by incorporating pre-defined keywords and phrases into a relational database platform alongside structured data, and by creating a process that accommodates full text search and retrieval for unstructured information that co-exists with structured elements

Regarding existing art, an example of sourcing structured and unstructured data, U.S. Pat. No. 8,751,486 to Neeman et al., and U.S. Pat. No. 8,683,311 to Penov et al., incorporated by reference herein for all purposes, provides for the extraction of unstructured data from various sources. There have also been inventions related to performing analysis with structured and unstructured data, as with U.S. Pat. No. 7,849,049 to Langseth et. al.

### BRIEF DESCRIPTION OF THE DRAWINGS

FIG. 1 is a flowchart for describing at a high level a sequence of function call processes in accordance with a preferred embodiment.

FIG. 2 presents a screenshot sample related to function calls that facilitate the contemporaneous analysis of structured and unstructured data in the context of identifying data relationships of interest. Charts can be created, new data series can be added, series can be modified with a variety of statistical and mathematical operations, and if desired users can save results as a descriptor set for later analysis or for exporting and sharing with others.

FIG. 3 presents a screenshot sample related to function calls that facilitate the contemporaneous analysis of structured and unstructured data in the context of converting descriptor sets into performance profiles. Function calls can be processed manually or in an automated batch mode, and can be made to be conditional upon the realization of a defined sequence of events as well as a preferred timing of the sequence. Favorable performance profiles can be translated into trading instructions for market brokers, and can be expanded in an automated fashion to identify additional scenarios where desired performance results are replicable. Performance profiles n be set up with alerts, and can be saved, exported and shared with others.

FIG. 4 presents the format and content of an input file relevant or executing an automated batch process to generate performance profiles.

FIG. 5 is a flowchart for describing in greater detail a sequence of function calls in accordance with a preferred embodiment.

### DETAILED DESCRIPTION

According to one or more embodiments, structured data refers to data that resides in a fixed field within a record or file, while unstructured data refers to information that does not naturally reside in a traditional row and column database. An example of structured data would include a time series of equity prices, and examples of unstructured data would include an annual report, internet blog, or news story.

For the present invention structured and unstructured data may reside in a variety of places and in a mix of formats. Individual search queries may be performed for a given structured-unstructured pairing, or batch processes involving multiple pairings may be processed sequentially or simultaneously. It is also possible to create a particular performance profile for a given structured-unstructured pairing and then seek to replicate that performance profile using alternative investments. Summary reports describing results of performance profiles may also be generated.

When search results are displayed in a chart, structured data points are referenced along the left vertical axis and unstructured data points are referenced along the right vertical axis. If the structured data points happen to correspond to equity prices, then equity prices are referenced on the left vertical axis, and the corresponding dates for those prices are presented along the horizontal axis. If the unstructured data points happen to correspond to the keyword “bullish”, then the right vertical axis references the number of times this keyword appears among the textual resources being searched, and are presented along the same horizontal dates axis as the structured data. If desired a user can display more than one equity price series with reference to the left vertical axis, and more than one keyword series can be displayed with reference to the right vertical axis. When multiple series are referenced, different legends are generated for differentiation purposes.

In the chart display mode, it is possible to perform additional analyses with respective time series by incorporating various statistical or mathematical modifications of the data. For example, in a statistical context, a user can superimpose a rolling correlation coefficient series or convert a series into a rolling moving average. Users can also convert series into momentum indicators, measures of relative strength, and a variety of other representations commonly used within the financial industry.

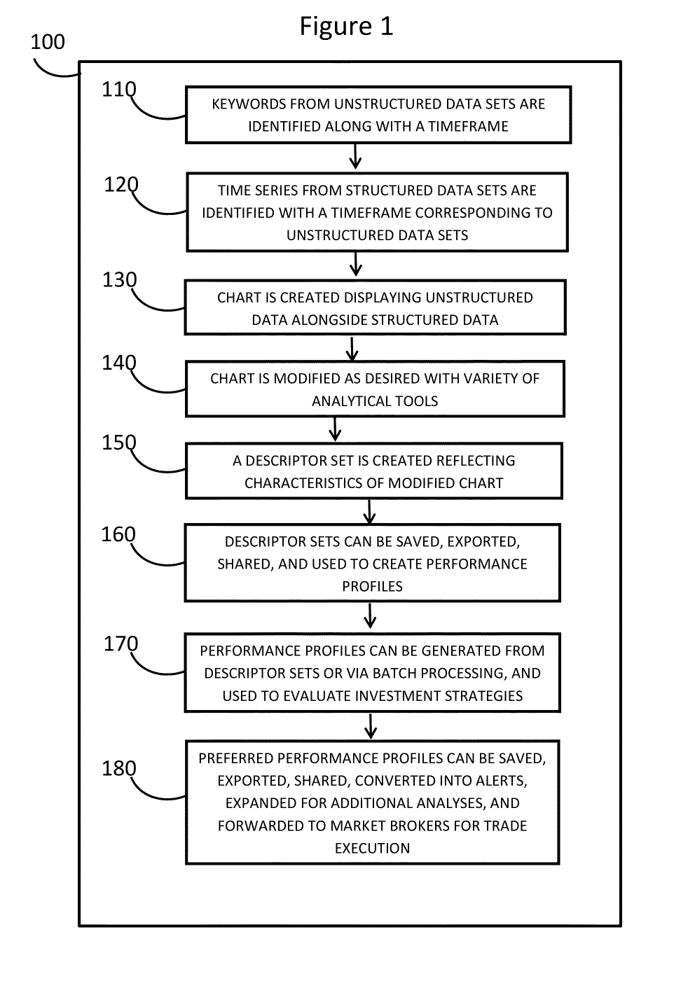

FIG. 1 illustrates a method 100 to bring structured and unstructured data into a single chart with the ability to perform additional analyses according to one embodiment. The method begins with the user identifying the keywords to be referenced from the unstructured data along with a timeframe of interest (step 110). A user then identifies the time series of interest from a structured database (step 120) corresponding to the same timeframe referenced for the unstructured data A chart is then created that displays the structured and unstructured datasets for the relevant timeframe (step 130).

Once the chart is created, a user may then proceed to modify it with a variety of analytical tools (step 140) comprised of statistical and mathematical operations. For example, the user may elect to convert one or more time series into a rolling moving average, a rolling correlation coefficient from a particular pairing of structured and unstructured data, or perform other statistical or mathematical operations.

When a user is satisfied with their modifications, a unique descriptor set may be created with reference to the modified chart (step 150). The descriptor set would include information on the sources of the structured and unstructured series, the particular content referenced within those sources, the dates and frequencies used, and any modifications made to any of the series. Descriptor sets can be saved, exported, and shared with others, and used to generate performance profiles (step 160). When a descriptor set is exported the underlying data to the various series are provided.

When a performance profile is created (step 170), information of a descriptor set is supplemented with details pertaining to a preferred investment strategy. These details could pertain to a user's investment strategy of buying shares of GE when a particular rolling correlation coefficient series has a value of zero, and then selling those shares when the rolling correlation coefficient series reaches a value of 0.80. Performance profiles can also be saved, exported, and shared with others, as well as be forwarded to market brokers and used to set up alerts (step 180). Alerts notify users when key performance profile parameters of interest reach certain thresholds. Performance profiles can also be expanded for additional analysis (step 180)

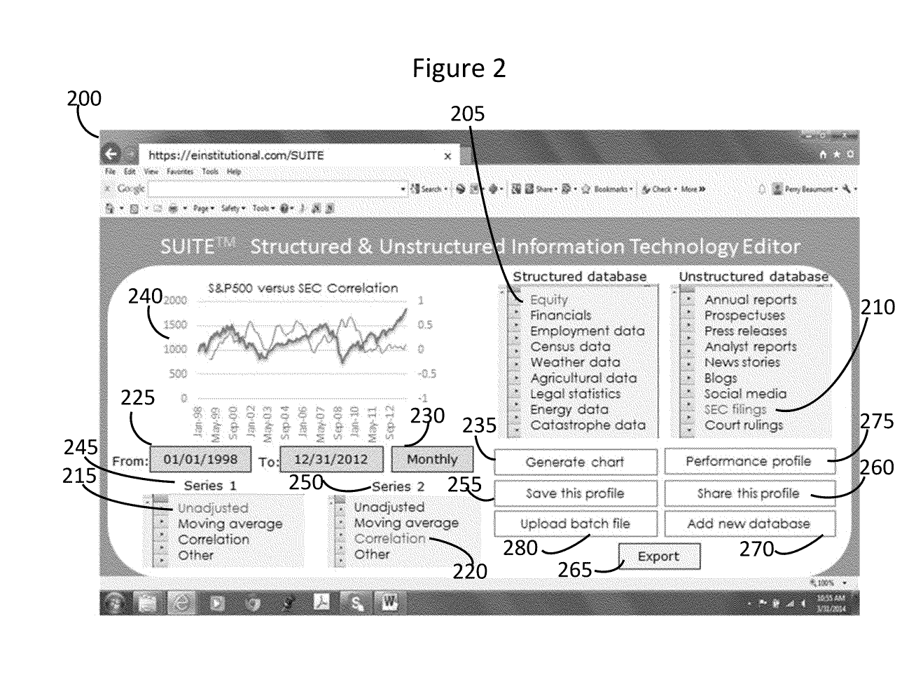

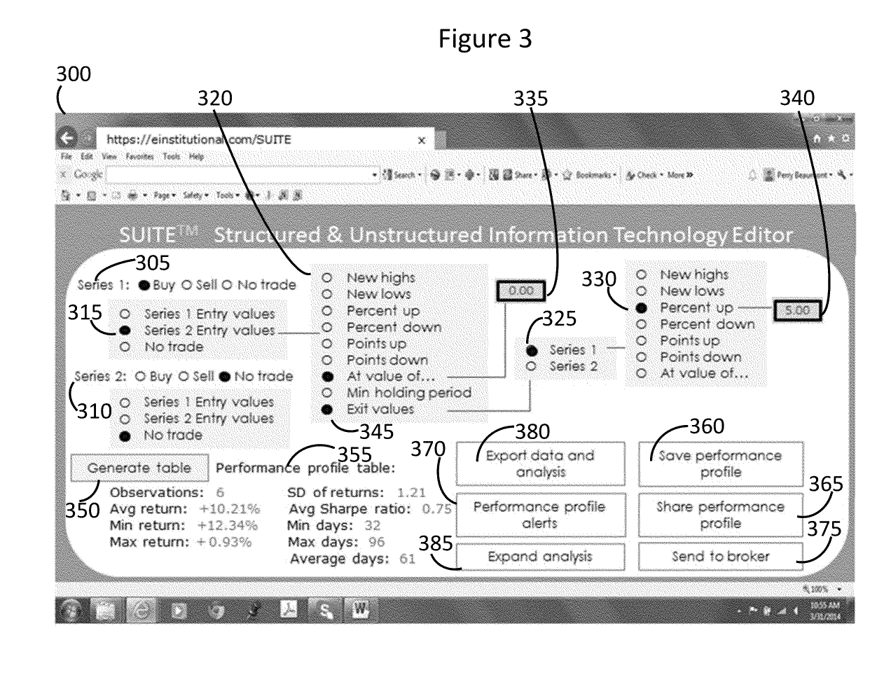

FIG. 2 illustrates an example of contemporaneously evaluating structured and unstructured data on manual basis within a single integrated software platform. For this context 200, the user begins by selecting a structured data series 205 and an unstructured data series 210. In this instance the structured data series is the S&P 500 and the unstructured data series is the phrase “legal opinion” as found in SEC filings available from EDGAR. The user also selects “Unadjusted” 215 for the structured series (“Series 1”), and “Correlation” 220 for the unstructured series (“Series 2”). “Unadjusted” means that the S&P 500 series will be presented in its traditional context of price levels, and “Correlation” means that a rolling correlation coefficient series will be generated with the correlation referencing price levels of the S&P500 and the number of instances when legal opinion is cited in documents filed with EDGAR. The user defines the start and end dates for the series 225, and selects the frequency of the data to be referenced 230. When the user selects “Generate chart” 235, a chart emerges 240 with the various features selected by the user. If the user wants to generate additional modifications to the chart, this is accomplished with reference to the options available under the headings of “Series 1” 245 and “Series 2” 250. Once a user has settled on a chart rendering, it may be saved for future reference 255, shared with another user 260, or exported 265. It is additionally possible for a new database to be added 270, and for a performance profile to be generated 275. If a user selects the performance profile option 275 additional information is required as shown in FIG. 3.

FIG. 3 illustrates how the descriptor set created in FIG. 2 can be supplemented with additional information to build performance profiles. For this context 300, a performance profile requires a user to indicate whether they are buying or selling (shorting) “Series 1” 305 or “Series 2” 310, or if they are not doing a trade in a particular series. In the example shown, the user is buying “Series 1” (the S&P 500) 305 and is not doing any trade in “Series 2” (the rolling correlation of “Series 1” and “Series 2”) 310. Although two series are shown with this example, multiple series may be referenced and with multiple buy and sell decision rules.

In addition to the user indicating that they want to buy “Series 1” 305, the user specifies the particular conditions under which they want to buy and subsequently unwind “Series 1”. These conditions form the decision rules of an investment strategy, and appear as a series of dropdown menus 320, 325, and 330. In our example the user enters into a purchase of “Series 1” when the value of “Series 2” is at a value of zero 335, and then exits the position in “Series 1” when “Series 1” trades five percent higher 340. “Series 1” 325 appears in a dropdown menu when the user selects “Exit values” 345, and “Percent up” 330 is an option that may be selected. When multiple Entry values and Exit values are involved, the user may additionally require that a particular sequence occur, and timeframes may be imposed as well. Each entry or exit value might have its own associated timeframe for occurrence, and each value may be required to occur more than once within an assigned timeframe prior to a buy or sell being made.

When the user selects “Generate table” 350, the performance profile table 355 is generated and presents a variety of useful information related to the selected decision rules over the timeframe selected 225 in FIG. 2. At this point the user can save 360 and share 365 the performance profile, create alerts 370 to be notified of future instances when certain parameter thresholds are reached, and send trade instructions to a market broker 375 within a template that translates the performance profile into buy or sell orders as appropriate. The user can also export the raw data and analysis 380 of the performance set for additional review, with the exported analyses including information useful for predictive analytics. Analysis can also be expanded 385 beyond the exhibited performance profile to include all other financial instruments of interest to a user. For example, if a particular performance profile is generated for GE and looks to be especially promising, the user may elect to have performance profile parameters applied to every equity within the S&P 500 to see if the performance profile is as promising with other candidates. If a batch process is preferred for generating performance profiles, then the batch file option 280 is selected as shown in FIG. 2.

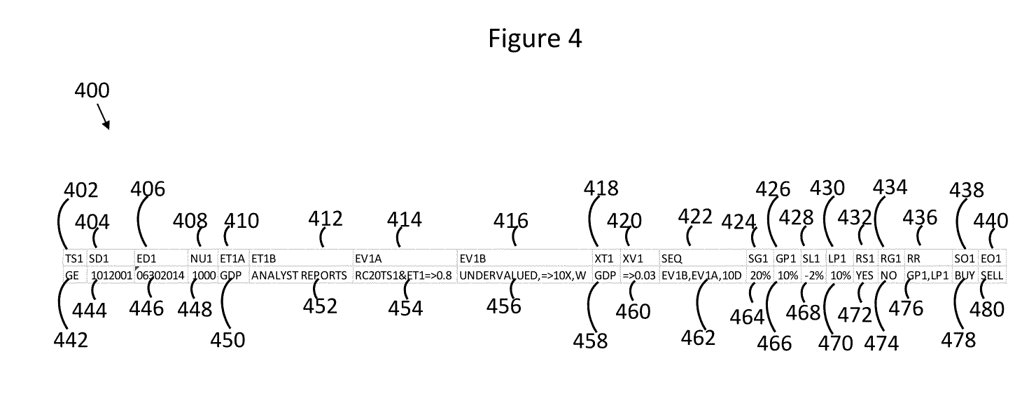

FIG. 4 illustrates how an input template 400 is to be completed when a user desires to have performance profiles run in an automated batch processing mode rather than on an individual case by case basis. The first parameter is TS1 402, and this designates the first Ticker Symbol for a particular financial instrument to be traded. In this instance the Ticker Symbol is the equity ticker for GE 442, and subsequent financial instruments are identified by “TS” followed by a number (as with TS2 for the second financial instrument to be traded, TS3 for the third financial instrument to be traded, and so forth). If a preferred frequency is desired for a Ticker Symbol that is something other than its default frequency, this can be indicated with the Ticker Symbol. For example, the frequency of GE's equity price can be expressed as weekly by stating “GE,W” where “W” connotes weekly observations. There may be only one Ticker Symbol and one frequency per financial instrument. If this field is left blank then the Entry Ticker field must be populated.

SD1 404 is the Start Date 444 (stated as MMDDYYYY) associated with the first Ticker Symbol (TS1), and indicates when the analysis is to commence. This field may not be left blank if the Ticker Symbol field is used.

ED1 406 is the End Date 446 (stated as MMDDYYYY) associated with the first Ticker Symbol (TS1), and indicates when the analysis is to finish. This field may not be left blank if the Ticker Symbol field is used.

NU1 408 is the Number of Units associated with the first Ticker Symbol (TS1), as with indicating one-thousand shares 448. This field may not be left blank if the Ticker Symbol field is used.

ET1 is the Entry Ticker associated with the first Ticker Symbol (TS1), or it may also be independent of the Ticker Symbol field if the Ticker Symbol field is left blank. An Entry Ticker (“ET”) can refer to either a structured data series such as GROSS DOMESTIC PRODUCT (or GDP) 450, or an unstructured data series such as ANALYST REPORTS 452. When the Ticker Symbol field is not blank, the function of an Entry Ticker is to identify what data series (structured or unstructured) is to be referenced for determining when a Ticker Symbol is initially bought or sold. There may be multiple Entry Tickers per Ticker Symbol. If TS1 were to have two Entry Tickers, they would be labelled as ET1A 410 and ET1B 412. There is no limit to the number of “ET” designations that can exist per Ticker Symbol. The Entry Ticker field may be left blank when the Ticker Symbol field is populated, and if the Ticker Symbol field is not populated then this field may not be left blank. If the Ticker Symbol field is not populated, the user may have the objective of simply evaluating one or more Entry Ticker data series and their relation to one another over time.

EV1 is the Entry Value associated with the first Entry Ticker (ET1), or a modification associated with the first Entry Ticker, or both. An Entry Value (“EV”) refers to the specific signal that initiates an action in its corresponding Entry Ticker. For example, if ET1 refers to a structured data series such as GDP, then EV1 might be stated as “=>0.01”. This means that if ET1 is associated with a Ticker Symbol field that is not blank, perhaps where TS1 is GE, then an opening transaction will be generated for GE when the condition of a one percent or greater GDP is satisfied. If ET1 refers to an unstructured data series such as ANALYST REPORTS and the user cares about the keyword UNDERVALUED being cited in analyst documents, an opening transaction will be generated for GE when the keyword UNDERVALUED is invoked in a particular way. The particular way that UNDERVALUED could be invoked might involve its being cited a minimum number of times among analyst documents within a given timeframe, as with EV1 being stated as “UNDERVALUED,=>10×,W” 456. “UNDERVALUED,=>10×,W” is a set of decision rules which require the keyword UNDERVALUED to occur a minimum of 10 times (“10×”) within the span of a week (“W”) prior to an opening action with GE. If desired, more than one keyword or phrase may be used and within the context of Boolean syntax. For example, if a user is interested in the keyword BUY and the keyword UNDERVALUED, then the Boolean syntax as presented in the Entry Value field would be “BUY OR UNDERVALUED,=>10×,W”.

If desired, it is possible for a Ticker Symbol to be the same as an Entry Ticker. For example, if GE were both the Ticker Symbol and the Entry Ticker, then the Entry Value could he set as the preferred price for where to initiate the buying of GE shares.

Modifications can also be made to raw data series when creating an Entry Value. A modification may consist of converting a structured or unstructured data series into a rolling moving average, creating a rolling correlation coefficient from two series, or any number of various modifications achieved through statistical or mathematical operations. For example, assume that a user selects the Ticker Symbol of GE, and the Entry Ticker of GDP for GROSS DOMESTIC PRODUCT. If the user wants to initiate an action in TS1 when the rolling correlation coefficient (or simply “rolling correlation” or “correlation”) between GE and GDP is equal to or greater than 0.8, we can state this in the Entry Value field as “RC20TS1&ET1=>0.8” 454. “RC” is for rolling correlation, “20” indicates a 20-day rolling coefficient, “TS1&ET1” indicates that the correlation is calculated between series TS1 and ET1, and “=>0.8” indicates that the rolling correlation must be equal to or greater than 0.8 for an action to be initiated with TS1. If more than one Entry Value were to be relevant so as to correspond to more than one Entry Event, then the user would reference EV1A 414 and EV1B 416 to correspond to ET1A and ET1B, respectively.

There may be only one “EV” per Entry Ticker. If the field for Entry Ticker is blank, then the Entry Value field would also be left blank. If the Ticker Symbol field were left blank then the Entry Event field would simply reflect instructions for the initiation of an action with the Entry Ticker.

XT1 418 is the Exit Ticker associated with the first Ticker Symbol (TS1), or it may also be independent, of the Ticker Symbol field if the Ticker Symbol field is left blank. An Exit Ticker (“XT”) can refer to either a structured data series such as GDP 458, or an unstructured data series such as ANALYST REPORTS. When the Ticker Symbol field is not blank, the function of an Exit. Ticker is to identify what data series (structured or unstructured) is to be referenced for determining when a Ticker Symbol is to be unwound from its original purchase or sale. There may be multiple Exit Tickers per Ticker Symbol. If TS1 were to have three Exit Tickers, they would be labelled as XT1A, XT1B, and XT1C. There is no limit to the number of “XT” designations that can exist per Ticker Symbol. For most use cases the Exit Ticker will be the same as the Entry Ticker; if GDP were to be the reference series for determining when to get into a transaction, then GDP would in most cases be the reference series for determining when to unwind that trade. There may be some use cases, however, when it is desired to have the Entry Ticker and Exit Ticker linked to different series. The Exit Ticker field may be left blank when the Ticker Symbol field is populated, and if the Ticker Symbol field is not populated then this field may not be left blank.

XV1 420 is the Exit Value associated with the first Entry Ticker (ET1), or a modification associated with the first Entry Ticker, or both. An Exit Value (“XV”) refers to the specific signal that generates a closing action in its corresponding Exit Ticker.

For example, if ET1 refers to a structured data series such as GDP, then XV1 might be stated as “=>0.03” 460. This means that if ET1 is associated with a Ticker Symbol field that is not blank, perhaps where TS1 is GE, then a closing transaction will be generated for GE when the condition of a three percent or greater GDP is satisfied. If ET1 refers to an unstructured data series such ANALYST REPORTS and the user cares about the phrase SELL RECOMMENDATION or simply the keyword SELL, a closing transaction could be generated for GE when SELL is invoked in a particular way. The particular way that SELL might be invoked is if it is cited a minimum number of times among analyst documents within a given timeframe, as with EX1 being stated as “SELL,=>10×,W”, which could correspond to the keyword SELL occurring a minimum of 10 times (“10×”) within the span of a week (“W”). Any common applications of Boolean functionality could also be referenced.

If desired, it is possible for a Ticker Symbol to be the same as an Exit Ticker. For example, if GE were both the Ticker Symbol and the Exit Ticker, then the Exit Value could be set as the preferred price for where to unwind shares of GE.

Modifications can also be made to raw data series when creating an Exit Value. There may be only one “XV” per Exit Ticker. If the field for Exit Ticker is blank, then the Exit Value field would also be left blank. If the Ticker Symbol field were left blank then the Exit Event field would simply reflect instructions for the completion of an action involving the Entry Ticker.

When multiple Entry Values and Exit Values are involved, the user may additionally require that a particular sequence in values occur prior to an action being taken, and timeframes for when values must occur may also be imposed. Each Entry Value and Exit Value might have its own associated timeframe for occurrence, and each may be required to occur more than once within an assigned timeframe. For example, if there were two Entry Values for TS1 (EV1A and EV1B), this means that two different occurrences must precede any initial action involving TS1. Of relevance is whether there is any importance to how the two different values evolve in relation to one another. It is for this reason that a “SEQ” field 422 exists. For example, if it were important for EV1B to occur ahead of EV1A, and for the two occurrences to take place within a span of ten days, this would be stated as “EV1B,EV1A,10D” 462 which would mean the following: EV1B must precede EV1A, and these two events must occur within a span of 10 days (“10D”). If the time span were not relevant this would be stated as “EV1B,EV1A”, and if both values had to occur on the same day this would be stated as “EV1B,EV1A,1D”. If the sequence of multiple Entry Values were of importance, and if particular Entry Values were to have their own timeframe, this could be expressed as “EV1A,EV1B,5D,EV1C,10D” which would mean the following: EV1A must precede EV1A, EV1B must precede EV1C, EV1B must occur within 5 days (“5D”) after EV1A, and EV1C must occur within 10 days (“10D”) after EV1B. If sequence, timeframe, and number of occurrences were of importance, this could be expressed as “EV1A,EV1B,2×,5D,EV1C,4×,10D” which would mean the following: EV1A must precede EV1B, EV1B must precede EV1C, EV1B must occur two times (“2×”) within 5 days (“5D”) after EV1A, and EV1C must occur four times (“4×”) within 10 days (“10D”) after EV1B. If multiple Exit Values were of relevance as well, the logic referenced here for Entry Values would apply, though the designation would be applicable instead of “EV”.

The sequential and temporal capabilities described herein are important attributes of the present invention. Appreciable differences in investment strategies can be obtained when the ordering of pre-investment events is altered, or when changes are made to the timing of when those events may occur. Total return disparities might be observed, for example, when reversing the investment criteria for firms that are emerging from bankruptcy. If a particular investment strategy requires that a firm emerging from bankruptcy first receive a credit upgrade from a major rating agency to be followed by publication of the emerging firm's plan of reorganization, investment results could significantly differ from an opposite chain of events. When a credit upgrade precedes a plan of reorganization, there may be the perception that a public endorsement of sorts has been made regarding the firm's efforts and with positive support for the firm's debt and equity valuations. Investors will then have the firm's own particular viewpoint when the plan of reorganization follows, though it may not be relied upon in the same manner as the more independent analysis of a rating agency. With this reasoning, the same reaction of positive support for the firm's debt and equity valuations might not be realized if the firm's plan of reorganization precedes a rating agency's arm's-length judgment. Additionally, if the two events of the upgrade and plan of reorganization were to immediately follow one another, a heightened sense of assurance and stability might prevail in the marketplace, relative to the two events occurring several months apart.

If there is an interest with the investment strategy for TS1 being managed in the timeframe from when a position in TS1 is originally opened and ultimately closed, then various stop loss and stop gain measures may be implemented.

SG1 424 is the Stop Gain associated with the first Ticker Symbol (TS1). A Stop Gain (“SG”) refers to the magnitude that TS1 must appreciate for a transaction to be unwound for a gain. For example, if TS1 were GE, then if SG1 is stated as “20%” 464 then this means that GE should be unwound at a price twenty percent higher from where it was bought. There may be only one “SG” per Ticker Symbol. This field may be left blank.

GP1 426 is the Gain Percentage associated with the first Ticker Symbol (TS1). A Gain Percentage (“GP”) refers to reducing the original number of TS1 shares held due to a Stop Gain (“SG”) threshold being reached. For example, if TS1 is the equity ticker for GE, then if GP1 were stated as “10%” 466 this means that 10% of the original shares in GE would be unwound at the designated Stop Gain (“SG”) level, and if GP1 were stated as “100%” then this would mean that the entire original position in GE would be unwound. There may be only one “GP” per Ticker Symbol. If the Stop Gain field is blank then this field would also be left blank, otherwise it is an optional field.

SL1 428 is the Stop Loss associated with the first Ticker Symbol (TS1). A Stop Loss (“SL”) refers to the value that TS1 must have for a transaction to be unwound at a loss. For example, if TS1 were the equity ticker for GE, then if SL1 is stated as “−2%” 468 then this means that GE would need to be unwound at a price two percent lower from where it was bought. There may be only one “SL” per Ticker Symbol. This field may be left blank.

LP1 430 is the Loss Percentage associated with the first Ticker Symbol (TS1). A Loss Percentage (“LP”) refers to reducing the original number of TS1 shares held due to a Stop Loss (“SL”) threshold being reached. For example, if TS1 were the equity ticker for GE, then if LP1 were stated as “10%” 470 then this means that 10% of the original position in GE would be unwound at the designated Stop Loss (“SL”) level, and if LP1 were stated as “100%” then this would mean that the entire original position in GE would be unwound. There may be only one “LP” per Ticker Symbol. If the Stop Loss field is blank then this field would also be left blank, otherwise it is an optional field.

RS1 432 is used for Recurring Stops, and is associated with LP1 whenever LP1 has a value less than 100%. For example, if TS1 were GE 442 and if LP1 were stated as “10%” 470, then setting RS1 to YES 472 would mean that 10% of the original position in GE would be reduced every time GE declined by successive increments of 2% 468. A 2% decline 468 in GE's original value would result in a 10% reduction 470 of the original amount held, a 4% decline in GE's original value would result in a 20% reduction of the original amount held, and so forth. If RS1 were set to NO then there would be no recurring stops, and only one stop loss reduction would occur. There may be only one “RS” designation per Loss Percentage. If the Loss Percentage field is blank then this field would also be left blank, otherwise it is an optional field.

RG1 434 is used for Recurring Gains, and is associated with GP1 426 whenever GP1 has a value less than 100%. For example, if TS1 were GE 442 and if GP1 466 were stated as “10”, then setting RG1 to YES would mean that 10% of the original position in GE would be reduced every time GE increased by successive increments of 20% 464. A 20% increase 464 in GE's original value would result in a 10% reduction 466 of the original amount held, a 40% increase in GE's original value would result in a 20% reduction of the original amount held, and so forth. If RG1 were set to NO 474 then there would be no recurring stops, and only one stop gain reduction would occur. There may be only one “RG” designation per Gain Percentage. If the Gain Percentage field is blank then this field would also be left blank, otherwise it is an optional field.

“RR” 436 is used for Replenished Reversals, and is used in conjunction with either GP1 or LP1 whenever either of these has a value less than 100%. The purpose of Replenished Reversals is to restore any previously reduced positions in TS1 if certain conditions are met. For example, if the original number of TS1 shares were reduced by 10% 470 the previous week due to a 2% drop 468 in the value of TS1, then Replenished Reversals would purchase back those shares during the next week if the 2% drop were erased with a 2% gain. Similarly, if the original number of TS1 shares were reduced by 10% 466 the previous week due to a 20% gain 464 in the value of TS1, then Replenished Reversals would sell back those shares during the next week if the 20% increase were erased with a 20% loss. This field may be left blank, it may be used for just a “GP” or for just a “LP”, or it may be used for both. If both were desired, the designation in the field for Replenished Reversals would be “GP1” for replenishing gains, “LP1” for replenishing losses, and “GP1,LP1” 476 for replenishing both gains and losses.

SO1 438 is the Start Order associated with the TS1. A Start Order (“SO”) refers to whether the initial transaction for TS1 is a BUY or SELL. If SO1 were stated as BUY 478, then the initial transaction is a purchase. If SO1 were stated as SELL then the initial transaction is considered a short-sale. There may be only one “SO” per Ticker Symbol. This field may not be left blank if the Ticker Symbol field is not blank.

EO1 440 is the Ending Order associated with TS1. An Ending Order (“EO”) refers to whether the final transaction for TS1 is BUY or SELL. If EO1 were stated as SELL 480, then the ending (unwinding) transaction is a sale. If EO1 were stated as BUY then the ending (unwinding) transaction is considered a buy-back. There may be only one “EO” per Ticker Symbol. This field may not be left blank if the Ticker Symbol is not blank.

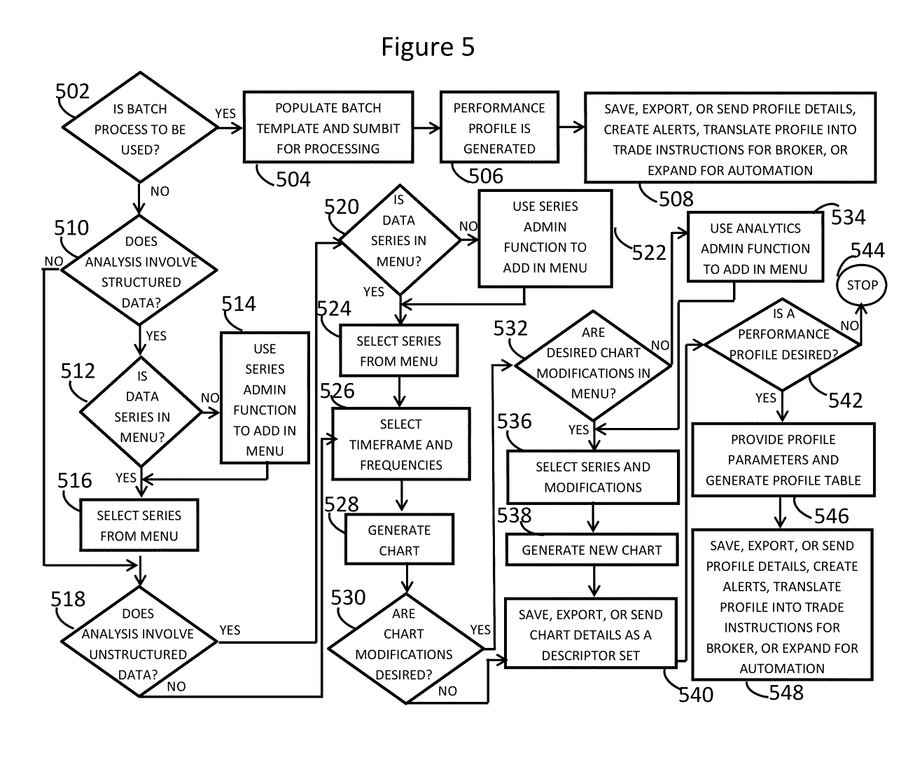

In a preferred embodiment of a more detailed flowchart of function calls presented in FIG. 5, the user starts with the decision of whether an automated batch process is to be used (step 502). If yes, then a batch input template is populated and submitted for processing (step 504) with the result of a performance profile being generated (step 506). The performance profile provides descriptive information related to the success of the various investment strategies defined by a user within the batch input template, and these performance results may be saved, exported, or sent to others (step 508). A user may also apply these results to create alerts for when certain investment strategy thresholds are reached, and results can be translated into trade instructions for a market broker (step 508). Results may also be expanded to see if desirable performance profiles are additionally applicable to other financial investments as selected by the user (step 508).

If a batch process is not to be used then the user indicates if their analysis will involve a structured data series (step 510). If yes, and if the desired structured series is available (step 512), then the series is selected (step 516). If no, the user has the option of having the desired dataset added to the menu of available structured series via a structured series admin call function (step 514) which then permits selection of the series (step 516). The user next indicates if their analysis will involve an unstructured data series (step 518). If yes, and if the desired unstructured series is already available in the menu (step 520), then the series is selected (step 524). If no, the user has the option of having the desired dataset added to the menu of available unstructured series via an unstructured series admin call function (step 522) which then permits selection of the series (step 524).

Whether an analysis is to involve structured series, unstructured series, or a contemporaneous evaluation of structured and unstructured series, a user must select a timeframe to be referenced and frequencies to be used (step 526) prior to a chart being generated (step 528).

Once a chart is generated the user may make modifications to any series with reference to a variety of statistical and mathematical operations. For example, if a user would like to convert a series into a rolling moving average, then this is achieved simply by selecting the relevant series along with the desired modification (step 530). If a desired modification is not available within the menu (step 532), then the user has the option of having the desired modification added via an analytics admin call function (step 534) which then permits selection of the modification (step 536). When desired modifications have been selected (step 536), a new chart is generated for review (step 538). At this juncture the user can save, export, or send details of the chart as a descriptor set (step 540). The user can additionally carry forward the descriptor set to create a performance profile (step 542) or simply stop the process (step 544).

Performance profiles build upon descriptor sets, and additionally permit a user to identify parameters for the creation of investment strategies (step 546). These parameters include, though are not limited to, specification of what series to buy or sell, what entry values ought to be referenced to initiate a trade, and what exit values should be referenced to unwind a trade. Once these selections are made, the user can generate a performance profile table (step 546) to evaluate the desirability of the investment strategy with the aid of descriptive statistics including, though not limited to, minimum, maximum, and average returns, the standard deviation of returns, and the average number of days from time of entry to time of unwind for each trade strategy that is completed within the selected timeframe. If desired, the user can save, export, or send performance profile details (step 548), create alerts for when performance profile parameters reach user-defined thresholds (step 548), and can have results translated into trade instructions for market brokers (step 548). It is additionally possible to expand a performance profile in an automated fashion when compelling investment results are initially obtained (step 548). For example, if a user finds that a particular combination of structured and unstructured data series result in especially favorable investment returns, then the process can be expanded by having a comparable analysis replicated for a large sample of equities or even an entire population (as with each equity within the S&P 500 index).

In one preferred embodiment, annotation function calls are written in PHP as a general purpose programming language to facilitate web development and connectivity with a variety of open source initiatives. Open source projects such as The R Project for Statistical Computing and Apache Hadoop are easily integrated with the present invention, and as such can appreciably extend the benefits of the invention's core functionality.

There are many ways that skilled artisans might accomplish the essential steps to produce an overall solution, other than with the specific steps and data structures described herein.

The flowcharts, screenshot samples, and presentations in the Figures illustrate the architecture, functionality, and operation of possible implementations of systems, methods and computer program products according to various embodiments of the present invention. In this regard, each block in a flowchart or other illustrations may represent a module, segment, or portion of code, which comprises one or more executable instructions for implementing the specified logical function(s). It should also be noted that, in some alternative implementations, the functions may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or illustrations, and combinations of blocks and illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A non-transitory computer-readable medium storing instructions that when executed by a computing device direct the processor to perform a method, the method comprising: the contemporaneous analyses of structured and unstructured data within a single integrated platform, wherein function calls may include information for searching, charting, modifying, exporting, and sharing; saving results of contemporaneous analyses within descriptor sets which can be recalled for additional analysis; transforming descriptor sets into performance profiles which can be used to create investment strategies; evaluating performance profiles with the aid of performance profile tables which provide historical performance results associated with decision rules created with reference to structured and unstructured datasets; devising decision rules with reference to entry values that determine when an investment strategy is originated, and exit values that determine when an investment strategy is unwound; saving results of performance profiles which can be recalled for additional analysis; translating performance profiles into trade instructions for a market broker inclusive of replenished reversals; invoking single or multiple function calls, successively or simultaneously; generating alerts linked to performance profile parameters; adding new structured or unstructured data series via a series admin call function, and adding new tools for statistical or mathematical analyses via an analytics admin call function; processing function calls on a manual basis or in automated batch mode; sequencing and timing entry values and exit values with reference to structured and unstructured data elements as a condition for investment strategies being implemented; expanding a given performance profile to permit an automated process of identifying preferred investment strategies; providing a summary report that details results of all function call activities inclusive of any calculations performed, especially those applicable as inputs for predictive analytics.

2. The method of claim 1, wherein the function call consists of charting, modifying, exporting, and sharing contemporaneous analyses of structured and unstructured data.

3. The method of claim 1, wherein the function call consists of saving results of contemporaneous analyses within descriptor sets which can be recalled for additional analysis.

4. The method of claim 1, wherein the function call consists of transforming descriptor sets into performance profiles which can be used to evaluate investment strategies.

5. The method of claim 5, further comprising the functionality of replenished reversals.

6. The method of claim 1, wherein the function call permits evaluating performance profiles with the aid of performance profile tables which provide historical performance results associated with decision rules created with reference to structured and unstructured datasets.

7. The method of claim 1, further comprising the functionality of saving results of performance profiles which can be recalled for additional analysis.

8. The method of claim 1, further comprising a type of function call consisting of translating performance profiles into trade instructions for a market broker.

9. The method of claim 1, further comprising functionality of invoking single or multiple function calls, successively or simultaneously.

10. The method of claim 1, further comprising the ability to generate alerts related to performance profile parameters.

11. The method of claim 1, further comprising the ability to add new structured or unstructured data series via a series admin call function.

12. The method of claim 1, further comprising the ability to add new tools for statistical or mathematical analyses via an analytics admin call function.

13. The method of claim 1, further comprising the ability to process function calls on a manual basis or in automated batch mode.

14. The method of claim 1, wherein the function call permits the sequencing of entry values or exit values that must evolve with structured and unstructured data elements contemporaneously as a condition for investment strategies being implemented.

15. The method of claim 1, further comprising functionality whereby a sequencing of entry values or exit values that must evolve with structured and unstructured data elements contemporaneously may additionally require the sequencing to be achieved within a specified timeframe as a further condition for investment strategies being implemented.

16. The method of claim 1, further comprising functionality whereby a sequencing of entry values or exit values that must evolve with structured and unstructured data elements contemporaneously may additionally require the sequencing to be achieved with respect to multiple timeframes as a further condition for investment strategies being implemented.

17. The method of claim 11, further comprising functionality whereby a sequencing of entry values and exit values that must evolve with structured and unstructured data elements contemporaneously may additionally require the sequencing to be achieved with respect to multiple timeframes whereby each entry value or exit value has its own unique associated timeframe.

18. The method of claim 1, further comprising functionality whereby a sequencing of occurrences that must evolve with structured and unstructured data elements contemporaneously may additionally require the sequencing to be achieved with respect to multiple timeframes whereby each entry value or exit value may be required to occur more than once as a further condition for investment strategies being implemented.

19. The method of claim 1, wherein the function call permits expanding a given descriptor set or performance profile to permit an automated process of identifying preferred investment strategies.

20. The method of claim 1, wherein the function call provides a summary report that details results of all function call activities inclusive of any calculations performed, especially those applicable as inputs for predictive analytics.

21. The method of claim 1, further comprising the ability to process structured and unstructured data on a single integrated platform.

22. The method of claim 1, further comprising the ability to process structured and unstructured data independent of wherever the data may reside, whatever form the data may have, and how the data is retrieved.
